(19) United States
(12) Patent Application Publication
(10) Pub. No.: US 2023/0106198 A1
(43) Pub. Date: Apr. 6, 2023

(54) Sensing Membrane for Torque Sensor Device and Torque Sensor Device

(71) Applicant: TE Connectivity Sensors France, Toulouse (FR)

(72) Inventors: Papa Aldemba Faye, Les Clayes Sous-Bois (FR); Arthur Vignolles, Les Clayes Sou-Bois (FR)

(73) Assignee: TE Connectivity Sensors France, Toulouse (FR)

(21) Appl. No.: 17/961,030

(22) Filed: Oct. 6, 2022

(30) Foreign Application Priority Data
Oct. 6, 2021 (EP) 21306406.6

(51) Int. Cl. G01L 3/10; B25J 9/16

(52) U.S. Cl. CPC G01L 3/108; B25J 9/1633

(57) ABSTRACT

A sensing membrane includes a first main surface forming a top of the sensing membrane, a plurality of measurement transducers formed over the first main surface, a second main surface opposite to the first main surface and forming a bottom of the sensing membrane, and a thickening element formed below the second main surface opposite to the measurement transducers.

### CROSS-REFERENCE TO RELATED APPLICATION

This application claims the benefit of the filing date under 35 U.S.C. § 119(a)-(d) of European Patent Application No. 21306406.6, filed on Oct. 6, 2021.

### FIELD OF THE INVENTION

The present invention relates to a sensing membrane and, more particularly, to a sensing membrane for a torque sensor device.

### BACKGROUND

Accurately detecting the torque of an object, for example, some driven shaft or joint, represents a problem that is of relevance in a plurality of applications. A particular application relates to the torque measurement during the movement of joints of robots. In a joint of a robot on which loads in various directions act, in order to accurately detect a torque in the rotation direction acting on the joint, usually some cancellation mechanism must be provided in order to exclude loads in directions other than the rotation direction from the measurement process. However, reliable exclusion of such loads is very difficult.

In the art it is known to compensate for loads in directions other than the rotation direction by means of Wheatstone circuitries and torque sensors comprising radially elastic torque transfer portions (see, for example, WO 2018/041948 A1). However, known torque sensor devices still suffer from a lack of accuracy of the torque measurements and exhibit relatively bulky configurations. Furthermore, conventional torque sensor devices are sensible against even minute dislocations of the measuring transducers formed on the sensitive membranes that, particularly, negatively affect the accuracy of measurements of torques.

Consequently, there is a need for a torque sensor device that allows for reliably accurate torque measurements and that can be formed in a compact light-weighted configuration that, in particular, allows for some manufacturing tolerance with respect to the positioning of the measurement transducers.

### SUMMARY

A sensing membrane includes a first main surface forming a top of the sensing membrane, a plurality of measurement transducers formed over the first main surface, a second main surface opposite to the first main surface and forming a bottom of the sensing membrane, and a thickening element formed below the second main surface opposite to the measurement transducers.

### BRIEF DESCRIPTION OF THE DRAWINGS

The invention will now be described by way of example with reference to the accompanying Figures, of which:

FIG. 1A is a plan view of a torque sensor device according to an embodiment;

FIG. 1B is a sectional perspective view of the torque sensor device of FIG. 1A;

FIG. 2 is a plan view of the torque sensor device of FIG. 1A with a first printed circuit board;

FIG. 3 is a perspective view of the torque sensor device of FIG. 2 with a second printed circuit board;

FIG. 4A is a perspective view of a torque measurement using the torque sensor device of FIG. 2;

FIG. 4B is another perspective view of a torque measurement using the torque sensor device of FIG. 2;

FIG. 4C is another perspective view of a torque measurement using the torque sensor device of FIG. 2;

FIG. 4D is another perspective view of a torque measurement using the torque sensor device of FIG. 2;

FIG. 5 is a plan view of a torque sensor device according to another embodiment;

FIG. 6 is a perspective view of a sensing membrane and a stiffener of a torque sensor device;

FIG. 7 is a sectional perspective view of the sensing membrane and the stiffener of FIG. 6; and

FIG. 8 is a plurality of graphs of a tilting moment applied to a sensing membrane and reduction of axial load applied to the sensing membrane in a region where a thickening element is provided.

### DETAILED DESCRIPTION OF THE EMBODIMENT(S)

Features and exemplary embodiments as well as advantages of the present disclosure will be explained in detail below with respect to the drawings. It is understood that the present disclosure should not be construed as being limited by the description of the following embodiments. It should furthermore be understood that some or all of the features described in the following may also be combined in alternative ways.

The present invention provides a sensing membrane and a torque sensor device that allows for accurately measuring the torque of an object, for example, a rotating shaft or a robot joint wherein the measurement is not significantly affected by axial or radial loads or tilting moments.

In particular, the torque sensor device can be used for sealing purposes, for example, for sealing a gear box. The torque sensor device is suitable for measuring the torque of a joint of a (collaborative) robot, for example. Torque control based on measurements made by the torque sensor device can be implemented in robots to facilitate robot-human interactions, for example.

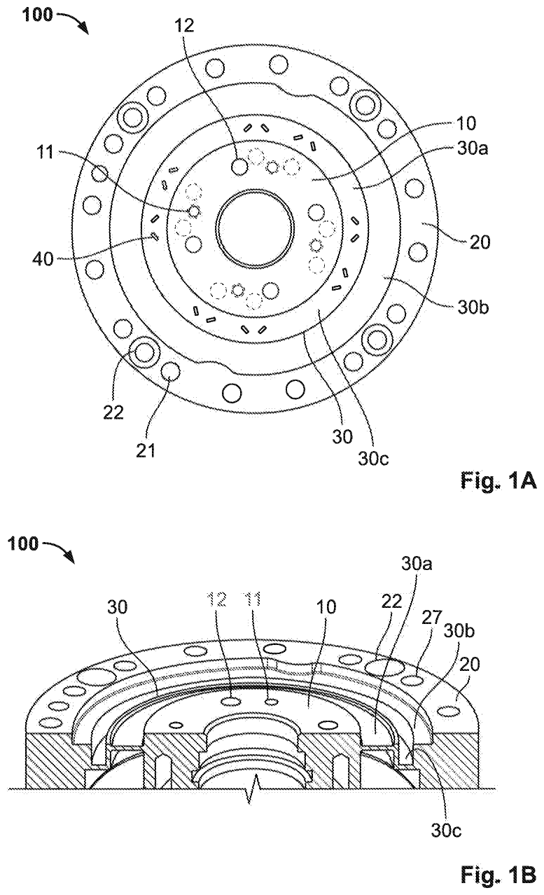

Exemplary embodiments of the inventive torque sensor device 100 are shown in FIGS. 1A and 1B. The torque sensor device 100 comprises an inner flange 10 and an outer flange 20. An intermediate portion 30 continuously extends radially from the inner flange 10 to the outer flange 20. The inner flange 10 and the outer flange 20 may be annular and the intermediate portion 30 has a circular shape. The inner flange 10, the outer flange 20, and the intermediate portion 30 form a circular body, for example, a monolithic circular body/membrane. In principle, the circular body may be a monolithic body or may comprise parts attached to each other. The circular body may consist of or comprise, for example, steel, aluminum, or an aluminum alloy. Different parts of the circular body may be made of different materials when no monolithic circular body is provided.

The intermediate portion 30 in an embodiment is a continuously solid portion; no openings extending through the entire material are formed in the intermediate portion 30. Thus, the intermediate portion 30 can serve as a seal, for example, for sealing a gear box, without requiring additional sealing elements. The intermediate portion 30 may at least partially may have a smaller thickness in an axial direction than the inner and/or outer flange 10, 20.

The intermediate portion 30 may comprises sub-portions 30a and 30b that might be separated from each other by a separator 30c. The separator 30c may be a rim or it may be a circumferential groove 30c as illustrated in FIG. 1B. Such a circumferential groove 30c may serve to orientate/direct the applied stress and strain with respect to the strain gage positions.

A plurality of pairwise measurement transducers 40 is formed on the intermediate portion 30, for example sub-portion 30a, as it is shown in the top view of the main surface of the torque sensor device 100 of FIG. 1A. The measurement transducers 40 are arranged symmetrically about an axis running through the center of the circular body perpendicular to the main surface (axial axis). The measurement transducers 40 can, in principle, be strain-sensitive transducers, in particular, strain gages, such as silicon gages, foil strain gages, and thin layer strain gages. The strain gages 40 may sense shear strain, particularly, oriented 45° inclined to the radial axis running through the center of the circular body in a direction parallel to the main surface of the circular body to which the strain gages 40 of a pair of strain gages are symmetrically arranged.

Moreover, in the inner flange 10, inner force application openings 11 and 12 of different sizes are formed and, in the outer flange 20, outer force application openings 21 and 22 of different sizes are formed. The inner and outer force application openings 11, 12, 21 and 22 may be bores extending in an axial direction. The bores are open at least one side or the respective flange and may have any suitable geometrical shape, for example, a circular or polygonal shape cross-section.

Torque to be measured is transferred, for example, by a rotating shaft under consideration and some static member, via connection members connected to the inner and outer force application openings 11, 12, 21, 22. Thereby, the torque applied between the inner and outer flanges 10, 20 can be measured.

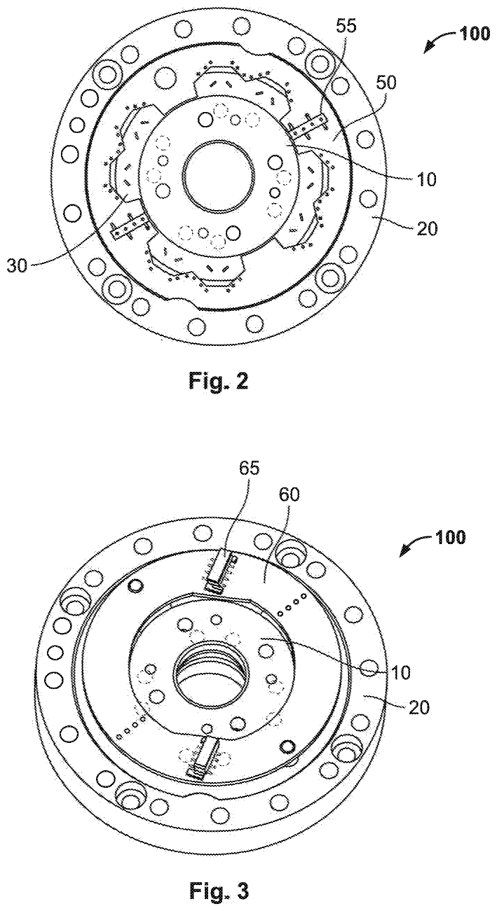

FIG. 2 shows the torque sensor of FIG. 1A or 1B wherein a first printed circuit board 50 comprising some circuitry devices as, for example, resistors and capacitors, and a connector 55 for connection to another printed circuit board 60 (see below) is provided over the intermediate portion 30. The measurement transducers 40 may be connected with an included measurement portion to the intermediate portion 30 and they may have free connecting portions for connection to the first printed circuit board 50 and, thus, the circuitry devices of the first printed circuit board 50. Particularly, the first printed circuit board 50 may comprise Wheatstone bridge elements (resistors) for converting an applied torque to voltage output signals. Depending on actual applications, half or full Wheatstone bridge may be used. The first printed circuit board 50 may also comprise a DC or AC excitation source for the Wheatstone bridge circuitry.

The first printed circuit board 50 may be covered by a second printed circuit board 60 as shown in FIG. 3. The second printed circuit board 60 protects the measurement transducers 40 and circuitry devices 55 against the environment. Particularly, the second printed circuit board 60 may have sensitive circuitry devices at the bottom (facing the first printed circuit boards 50) and a connector 65 for connection to the first printed circuit board 50. The second printed circuit board 60 is configured for signal conditioning, for example, for analogue-to-digital conversion of voltage output signals supplied by the circuitry devices of the first printed circuit board 50. Signal conditioning may also include amplification of voltage output signals supplied by the circuitry devices of the first printed circuit board 50.

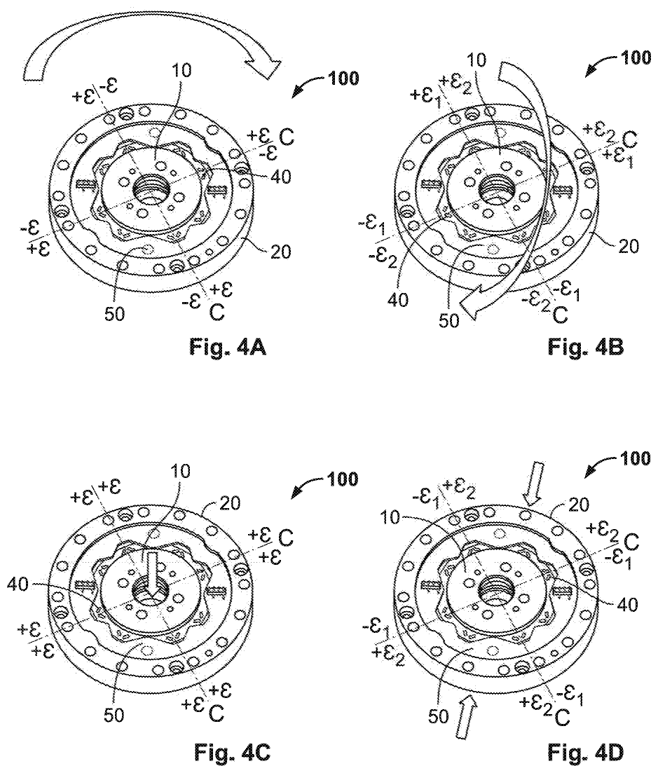

As already mentioned, measurement transducers 40 can be arranged about an axial axis running through the center of the circular body in a direction perpendicular to the main surface of the circular body. For example, one or two pairs of measurement transducers 40 may be arranged spaced apart from one or two neighboring pairs of measurement transducers 40 by 90° in a circumferential direction. FIGS. 4A to 4D illustrate an embodiment wherein strain gages 40 are arranged pairwise symmetrically about an axial axis running through the center of the circular body in a direction perpendicular to the main surface of the circular body and wherein two measuring channels C are defined by opposing pairs of strain gages 40 that are spaced apart from each other by 90° (from one channel to the other channel) in a circumferential direction. Each measuring channel C runs through the center of particular pairs of strain gages 40 that are arranged opposite to each other.

A torque (indicated by the arrow in FIG. 4A) can be measured based on a differential strain +ϵ and −ϵ where +ϵ is experienced by one strain gage of a pair of strain gages 40 and −ϵ is experienced by the other strain gage of the pair of strain gages 40. The strain gages 40 are connected to a Wheatstone bridge circuitry formed on a printed circuit board 50. Due to the selected geometry of the arrangement of the strain gages 40 (and the corresponding architecture of the Wheatstone bridge circuitry) the voltage output signal supplied by the Wheatstone bridge circuitry caused by an applied torque (strain in the intermediate portion of the torque sensor device on which the strain gages 40 are provided for sensing the strain) is proportional to Σϵ=4 ϵ+4 ϵ=8 ϵ, i.e., a sufficiently high wanted voltage output signal can be provided.

On the other hand, perturbations due to tilt and axial and radial loads can be largely suppressed as illustrated in FIGS. 4B to 4D. The arrow in FIG. 4B indicates a tilt that might be applied to the torque sensor device. The tilt applied to the torque sensor device 100 results in differential strains +ϵ1 and +ϵ2, +ϵ2 and +ϵ1, −ϵ2 and −ϵ1, and −ϵ1 and −ϵ2, respectively, for the four pairs of strain gages 40 defining the measuring channels C. Accordingly, the strain caused by the tilt is compensated by the chosen geometry of the arrangement of the strain gages 40 (and the corresponding architecture of the Wheatstone bridge circuitry): Σϵ=ϵ1−ϵ1+ϵ2−ϵ2=0 such that it does not contribute to a voltage output signal being proportional to the applied torque a shown in FIG. 4A.

In order to achieve an accurate torque measurement, it is also necessary to compensate for any axial loads. Such kind of compensation can also be achieved by the selected geometry of the arrangement of the strain gages 40 (and the corresponding architecture of the Wheatstone bridge circuitry) as it is illustrated in FIG. 4C (the arrow indicates the applied axial load). The axial load (due to the axially symmetrically arrangement of the strain gages 40) results in strains +ϵ at each of the strain gages 40 and, therefore, in a zero net effect: Σϵ=4 ϵ−b ϵ. With respect to compensating for tilt and axial loads, it might be advantageous to locate the strain gages 40 at the same radial distance to the inner flange 10 and to the outer flange 20.

Compensation for radial loads by the selected geometry of the arrangement of the strain gages 40 (and the corresponding architecture of the Wheatstone bridge circuitry) is illustrated in FIG. 4D. The applied radial load is indicated by the arrows. The radial load results in differential strains −ϵ1 and +ϵ2, +ϵ2 and −ϵ1, −ϵ1 and +ϵ2, and +ϵ2 and −ϵ1, respectively, for the four pairs of strain gages 40 defining the two measuring channels C. Accordingly, the contribution to the voltage output signal of the Wheatstone bridge circuitry of the printed circuit board 50 is proportional to Σϵ=−2 ϵ1+2 ϵ2+2 ϵ1−2 ϵ2=0.

However, exact compensation for radial loads as illustrated in FIG. 4D might not be achieved if some radial loads are applied in a radial direction shifted with respect to the measuring channels C in the circumferential direction by 22.5°. In this case, some Σϵ≠0 may occur and negatively affect the accuracy of the measurement of the torque. In order to alleviate this problem, some radially elastic portion by be provided in the intermediate portion 30 of the torque sensor device 100. The radially elastic portion by be realized by some groove 30c as illustrated in FIG. 1B. The radially elastic portion may be machined on the top or the bottom of the intermediate portion 30.

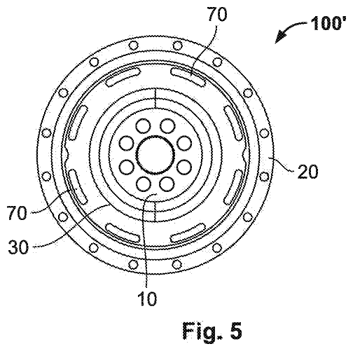

According to another approach, the problem of non-compensation of radial loads that are applied in a radial direction shifted with respect to the measuring channels C in the circumferential direction by 22.5° tapered out portions 70 can be formed in the intermediate portion 30 of the torque sensor device 100′ as it is illustrated in FIG. 5. The tapered out portions 70 may be machined on the top or the bottom of the intermediate portion 30. In the embodiment shown in FIG. 5, the tapered out portions 70 are arranged closer to the outer flange 20 than the inner flange 10 at the 22.5° positions. The tapered out portions 70 have larger dimensions in the circumferential direction than the radial direction.

Experiments have proven that such an arrangement of the tapered out portions 70 significantly reduces any contributions of the corresponding radial loads to Σϵ and, thus, the measurement result. It has to be noted that the tapered out portions 70 must not be punched through the intermediate portion 30 in order not to drop the advantageous sealing property of the torque sensor device 100′.

In accordance with the above-describe embodiments, an accurately operating torque sensor device can be provided in a compact design with a reduced height as compared to the art and at low costs. It can seal a gear box without the need for any additional sealing means and provide at least a two channel measurement. Particularly, all of the measurement transducers involved can be formed on one and the same surface of the intermediate portion 30 of the torque sensor device 100, 100′ described above.

Furthermore, a sensing membrane 200 as described in the following is provided. The sensing membrane 200 may be or may be comprised in the circular body of the torque sensor device of one of the above-described embodiments. The sensing membrane 200 comprises a thickening element that, according to embodiments, may be also comprised in the circular body of the torque sensor device of one of the above-described embodiments.

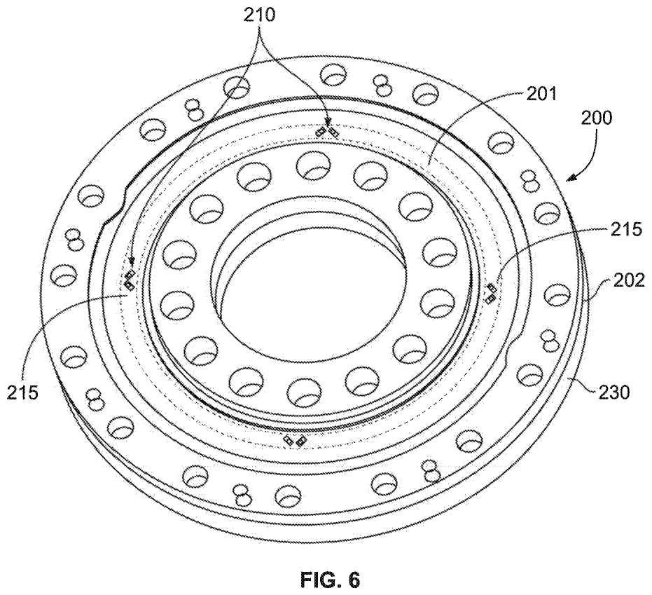

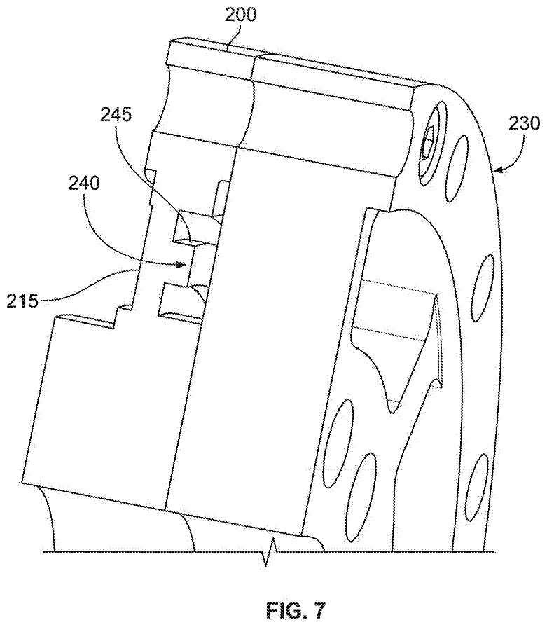

FIG. 6 shows a circular sensing membrane 200 provided herein. FIG. 7 shows a cross-sectional view of the configuration shown in FIG. 6.

The sensing membrane 200 has a first (upper) main surface 201 and a second (lower) main surface 202. The sensing membrane 200 may consist of or comprise, for example, steel, aluminum or an aluminum alloy. Measurement transducers 210 are provided in a circular transducers area 215. The measurement transducers 210 may comprise or consist of at least one of silicon gages, foil strain gages, and thin layer strain gages. The circular transducers area 215 may be formed in a thinned region of the sensing membrane 200. The sensing membrane 200 according to the embodiment shown in FIG. 6 comprises regions of different thicknesses. Alternatively, the sensing membrane 200 may have a uniform thickness. Arrangement of the measurement transducers 210 and structuring of the sensing membrane 200 shown in FIG. 6 may be similar or equal to arrangements described above and the structuring of circular body described above and shown in FIGS. 1 to 4B.

Optionally a stiffener 230 is attached to the second (lower) main surface 202 of the sensing membrane 200. For example, the stiffener 230 may be thicker than the sensing membrane 200. A thickness of the stiffener 230 may be in the range of 150% to 400% of the average thickness of the sensing membrane 200. The stiffener 230 may be made of the same material as the sensing membrane 200 and may be attached to second main surface 202 of the sensing membrane 200 by (laser) welding or by a screw assembly.

The stiffener 230 may be provided in order to reduce sensitivity of a torque sensor device to cross loads. For example, in the context of robots torque measurement of robot joints/arms might be negatively affected by cross loads, particularly, when cross roll bearings are not provided for cost reasons. Provision of the stiffener 230 provides a high stiffness against cross and axial loads but does not influence significantly sensitivity regarding torque.

As can be seen in FIG. 7, a circular thickening element (raiser) 240 is formed below the circular transducers area 215 of the sensing membrane 200. The thickening element 240 may be continuously formed or may comprise discontinuations (along the circle) between actual pairs of measurement transducers 210. In particular, the thickening element 240 may be arranged opposite to the measurement transducers 210. The thickening element 240 is formed below the second main surface 202 (for example, only) opposite to the measurement transducers 210, i.e. the thickening element 240 extends from the second main surface 202 in a direction opposite to the direction towards the top of the sensing membrane 200. Moreover, the thickening element 240 extends parallel to the second main surface 202.

The thickening element 240 may be integrally formed with the sensing membrane 200. In the embodiment shown in FIG. 7, the thickening element 240 is basically formed in a u-shape or v-shape with sidewalls 245 extending perpendicular from the second main surface 202 of the sensing membrane 200 in the transducers area 215. Other geometrical shapes are possible. For example, the u-shape may be amended by rounding the corners whereby a rounded convex shape of the thickening element 240 is obtained.

The thickening element 240 may extend perpendicular to the second main surface 202 with a height of at least 25% of the thickness of the sensing membrane 200 in a transducers area 215 where the measurement transducers are positioned and at most 150% of the thickness of the sensing membrane 200 in the transducers area 215 where the measurement transducers 210 are positioned.

During the manufacture of the sensing membrane 200 and a torque sensor device comprising the same, one or more of the measurement transducers 210 may be slightly dislocated with respect to radial and/or angular positions. As already mentioned, the arrangement of the measurement transducers 210 may be similar or equal to the kinds of arrangement described above. The accuracy of the positioning of the measurement transducers 210 is crucial for the insensitivity of the torque sensor device comprising the sensing membrane 200 to cross loads. The thickening element 240 homogenizes strain applied to the circular transducers area 215 and, therefore results in a lower sensitivity to manufacturing tolerances that cause axial loads applied to the sensing membrane 200/transducers area 215 as compared to the art.

Provision of such a thickening element 240 is counterintuitive since in the art the cross sections of measurement transducers zone are intentionally reduced as much as possible in order to increase the application of stresses caused by the torques that are to be measured. However, it was found that the provision of the thickening element 240 gives raise to a more homogeneous stress/strain applied to a transducers area (measurement area) of the sensing membrane 200 and, therefore, manufacturing tolerances do less significantly negatively affect measurement results. Particularly, dislocations of the measurement transducers 210 caused by manufacturing tolerances can be counterbalanced by the more homogeneous application of strains to the transducers areas. Desirably, insensitivity against cross loads can be obtained/increased by the provision of the thickening element 240.

Experiments have shown that employment of a u-shaped or convex shaped thickening element 240 with a height perpendicular to the second main surface 202 of the sensing membrane 200 in the transducers area 215 between 0.25 to 1 times the thickness of the sensing membrane in the transducers area 215 may result in a rigidity (insensitivity) against tilt moments of about twice the rigidity for the case without a thickening element 240. When the stiffener 230 is additionally provided the rigidity gain against tilting moments is up to a factor of 5 or even 10 depending on the actual geometric shape of the thickening element 240.

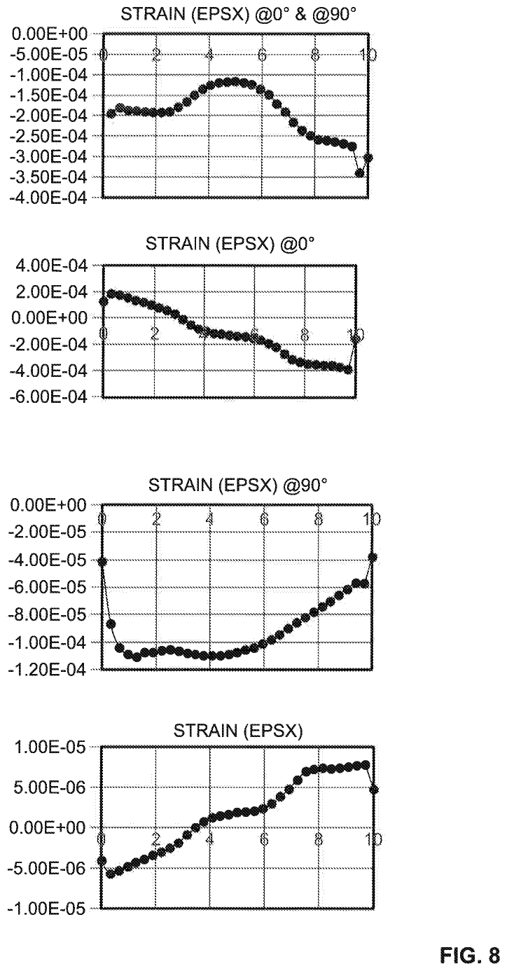

FIG. 8 exemplarily illustrates the homogenization of strain applied to the transducers area 215 of the sensing membrane 200 caused by the thickening element 240. Strain as a function of a radial position of the measurements is shown. The upper graph shows the homogenization effect on applied torque, the two central graphs show the homogenization effect on applied tilt, and the lower graph shows the suppression of axial load. The gentler slopes (plateaus) caused by the thickening element 240 can be easily identified.

Additionally, a method of measuring a torque of a shaft positioned in a gear box is provided, in particular, a gear box of a joint of a robot, the method comprising attaching the torque sensor device 100 according to one of the above-described embodiments to the gear box such that the gear box is sealed and measuring the torque by the torque sensor device 100 that is sealing the gear box.

What is claimed is:

1. A sensing membrane, comprising:
a first main surface forming a top of the sensing membrane;
a plurality of measurement transducers formed over the first main surface;
a second main surface opposite to the first main surface and forming a bottom of the sensing membrane; and
a thickening element formed below the second main surface opposite to the measurement transducers.

2. The sensing membrane of claim 1, wherein the sensing membrane is a circular sensing membrane and the measurement transducers are arranged in a circular transducers area of the sensing membrane.

3. The sensing membrane of claim 2, wherein the thickening element is arranged opposite to the circular transducers area.

4. The sensing membrane of claim 1, wherein the thickening element includes a u-shaped or a v-shaped step portion having a plurality of sidewalls extending perpendicular from the second main surface.

5. The sensing membrane of claim 1, wherein the thickening element extends perpendicular to the second main surface with a height of at least 25% of a thickness of the sensing membrane in a transducers area in which the measurement transducers are positioned and at most 150% of the thickness of the sensing membrane in the transducers area.

6. The sensing membrane of claim 1, wherein the thickening element is formed integrally with the second main surface.

7. The sensing membrane of claim 1, wherein the measurement transducers are positioned axially symmetrically to an axis extending through a center of the sensing membrane in a direction perpendicular to the first main surface and the second main surface.

8. The sensing membrane of claim 7, wherein the measurement transducers include at least two pairs of measurement transducers, the measurement transducers of each of the pairs are symmetrical to the axis extending through the center of the sensing membrane in a direction parallel to the first main surface and the second main surface.

9. The sensing membrane of claim 8, wherein the measurement transducers include at least four pairs of measurement transducers.

10. The sensing membrane of claim 9, wherein, for each of the four pairs of measurement transducers, the axis extending through the center of the sensing membrane in the direction parallel to the first main surface and the second main surface about which the pair of measurement transducers are symmetrical is spaced from the axis of symmetry of an adjacent pair of measurement transducers by 90° in a circumferential direction.

11. A torque sensor device, comprising:
a sensing membrane including a first main surface forming a top of the sensing membrane, a plurality of measurement transducers formed over the first main surface, a second main surface opposite to the first main surface and forming a bottom of the sensing membrane, and a thickening element formed below the second main surface opposite to the measurement transducers.

12. The torque sensor device of claim 11, further comprising a stiffener arranged below the second main surface.

13. The torque sensor device of claim 12, wherein the stiffener is attached to the second main surface.

14. The torque sensor device of claim 13, wherein the stiffener is attached to the second main surface by a weld or by a fastening device.

15. The torque sensor device of claim 12, wherein the stiffener has a thickness larger than an average thickness of the sensing membrane.

16. The torque sensor device of claim 15, wherein the thickness of the stiffener is 150% to 400% of the average thickness of the sensing membrane.

17. A robot, comprising:
a torque sensor device having a sensing membrane including a first main surface forming a top of the sensing membrane, a plurality of measurement transducers formed over the first main surface, a second main surface opposite to the first main surface and forming a bottom of the sensing membrane, and a thickening element formed below the second main surface opposite to the measurement transducers.

18. The robot of claim 17, further comprising a joint having a gear box, the torque sensor device is attached to the joint.

19. The robot of claim 18, wherein the joint does not have a cross roller bearing.
